(19) United States
(12) Patent Application Publication
(10) Pub. No.: US 2001/0016256 A1
(43) Pub. Date: Aug. 23, 2001

(54) Dielectric ceramic powder for miniaturized multilayer ceramic capacitors and method for the manufacture thereof

(75) Inventor: Hirokazu Chazono, Tokyo (JP)

Correspondence Address: SHAHAN ISLAM, ESQ., ROSENMAN & COLIN LLP, 575 Madison Avenue, New York, NY, 10022-2585, US

(73) Assignee: Taiyo Yuden Co., Ltd., Tokyo (JP)

(21) Appl. No.: 09/775,773

(22) Filed: Feb. 2, 2001

(30) Foreign Application Priority Data
Feb. 3, 2000 (JP) 2000-026459

(51) Int. Cl. B32B 9/00

(52) U.S. Cl. 428/325; 428/402

(57) ABSTRACT

The maximum particle diameter of the primary particles in dielectric ceramic powder for use in manufacturing dielectric layers of a multilayer ceramic capacitor has a direct relation with the ratios of defective multilayer ceramic capacitors. A multilayer ceramic capacitor having dielectric layers manufactured by dielectric ceramic powder, wherein the maximum particle diameter of the primary particles in the dielectric ceramic powder is not greater than 3 μm, can be scaled down and have a higher capacitance without deteriorating the yield.

### FIELD OF THE INVENTION

The present invention relates to dielectric ceramic powder for use in producing a dielectric of a multilayer ceramic capacitor, a ceramic green sheet and a multilayer ceramic capacitor manufactured by using the dielectric ceramic powder and a method for the manufacture thereof.

### BACKGROUND OF THE INVENTION

A multilayer ceramic capacitor is typically manufactured as follows: First, a slurry having a desired viscosity is prepared by stirring and mixing dielectric ceramic powder of, e.g., BaTiO₃ with a binder and a dispersion agent in a ball mill for several hours.

Next, a green sheet is prepared by a doctor blade method, wherein, the slurry is discharged onto a carrier film through a small orifice and the carrier film is pulled under a doctor blade, which is set at a particular height to obtain a desired sheet thickness. The sheet is then dried to produce the green sheet.

Then, a conductive paste is applied on a number of green sheets to form internal electrodes thereon. The desired number of ceramic green sheets thus produced to have the internal electrodes thereon are stacked and compressed to form a laminated body. The laminated body is then diced into a number of capacitor elements having a predetermined size. Thereafter the capacitor elements are sintered and finally external electrodes are formed on the opposite end portions of each of the capacitor elements to produce multilayer ceramic capacitors.

Nowadays conductive and dielectric layers of a multilayer ceramic capacitor have been getting thinner and thinner to meet the continuous need for a scaled-down and high capacitance multilayer ceramic capacitor. Such a multilayer ceramic capacitor, however, suffers from deteriorated yield problems incurred by scaling-down of the dielectric layer thickness. Defect generation in such a scaled-down multilayer ceramic capacitor is directly related with the inclusion of large particles in the dielectric ceramic powder. There are two types of particles in the ceramic powder, i.e., a primary particle and a secondary particle formed by the aggregation of the primary particles. The term “primary particles” used herein denotes separate particles included in the dielectric ceramic powder without being aggregated to form a larger secondary particle. If the large particles causing defects in the multilayer ceramic capacitors are of the secondary particles, they can be relatively easily ground into the primary particles. However, if the large particles are of the primary particles, a large amount of energy is required to crush them into smaller pieces and dust particles are produced while grinding. The dust particles thus produced degrade electrical properties of the multilayer ceramic capacitors.

### SUMMARY OF THE INVENTION

It is, therefore, an object of the present invention to provide dielectric ceramic powder, a ceramic green sheet and a multilayer ceramic capacitor enabling the scaling-down of the thickness of a dielectric ceramic layer in the multilayer ceramic capacitor and method for the manufacture thereof.

In accordance with one aspect of the present invention, there is provided dielectric ceramic powder for use in forming a dielectric layer of a multilayer ceramic capacitor, wherein none of diameters of the primary particles included in the dielectric powder are greater than 3 μm.

In accordance with another aspect of the present invention, there is provided a ceramic green sheet, for a multilayer ceramic capacitor, manufactured by using dielectric ceramic powder, wherein the dielectric ceramic powder does not include any primary particle whose diameter is greater than 3 μm.

In accordance with still another aspect of the present invention, there is provided a multilayer ceramic capacitor made by stacking a number of ceramic green sheets on which conductive layers are disposed, wherein the ceramic green sheets are manufactured by using dielectric ceramic powder including primary particles, and none of the diameters of the primary particles included in the dielectric ceramic powder are greater than 3 μm.

In accordance with still another aspect of the present invention, there is provided a method for manufacturing a multilayer ceramic capacitor made by stacking a number of ceramic green sheets on which conductive layers are disposed, wherein the ceramic green sheets are formed by using dielectric ceramic powder including primary particles and a maximum particle diameter of the primary particles is not greater than 3 μm.

### BRIEF DESCRIPTION OF THE DRAWINGS

The above and other objects and features of the present invention will become apparent from the following description of preferred embodiments given in conjunction with the accompanying drawings, in which:

FIG. 1 shows a distribution of particle diameters in the dielectric ceramic powder of the present invention;

FIG. 2 is a distribution of the particle diameters in the dielectric ceramic powder of the prior art;

FIG. 3 illustrates a cross-sectional view of a multilayer ceramic capacitor; and

FIG. 4 describes manufacturing steps of a multilayer ceramic capacitor of the present invention.

### DETAILED DESCRIPTION OF THE PREFERRED EMBODIMENTS

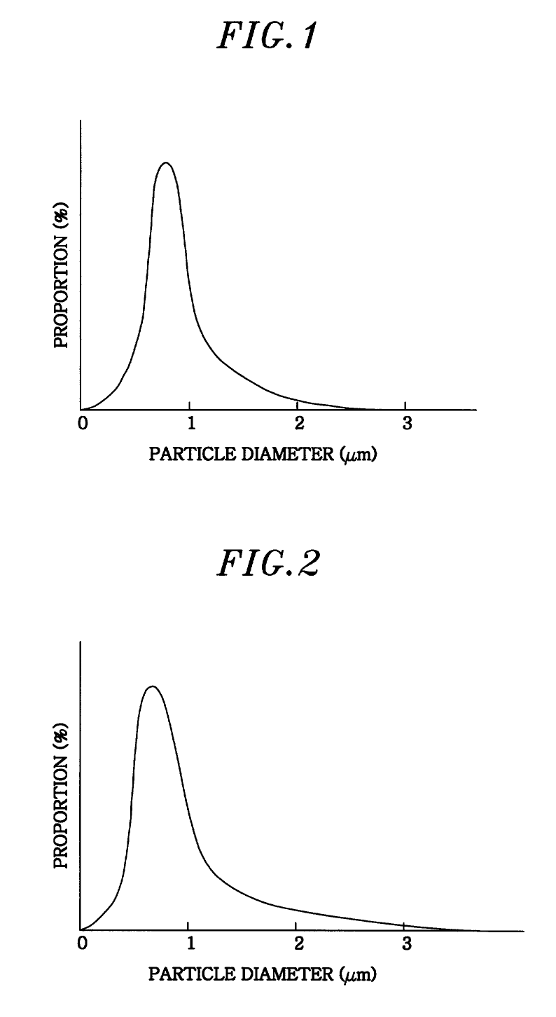

Referring to FIG. 1, there is illustrated an exemplary distribution of particle diameters in dielectric ceramic powder of the present invention. FIG. 2 shows an exemplary distribution of particle diameters in dielectric ceramic powder of the prior art. As shown in FIG. 1, diameters of primary particles of dielectric ceramic powder of the present invention are not greater than 3 μm, and preferably not greater than three times the mean diameter of the particles, and more preferably not greater than 1 μm. The dielectric ceramic powder of the invention does not include any primary particle with a diameter being greater than 3 μm. In other words, a maximum diameter of the primary particles of the dielectric ceramic powder of the present invention is not greater than 3 μm, and preferably not greater than three times the mean diameter of the particles, and more preferably not greater than 1 μm. It is to be noted that any dielectric ceramic powder having a primary particle whose particle diameter is greater than 3 μm as shown in FIG. 2 is not included in the scope of the present invention even though a mean particle diameter thereof is very small.

The mean diameter of the particles included in the dielectric ceramic powder has been determined as follows: First, not less than 300 primary particles randomly selected in the dielectric ceramic powder are observed by an SEM (Scanning Electron Microscope) and each diameter thereof is measured by means of, e.g., a micrometer scales on the monitor of the SEM. Next, the volume of each primary particle is calculated by assuming that each primary particle is spherical and the total volume of the particles is obtained by summing the volumes of all the particles. Then, the volumes of particles are accumulated in an ascending order of particle diameter starting from the minimum and if the accumulated sum up to a jth diameter is closest to 50% of the total volume, the jth diameter is determined as the mean diameter of the particles. For instance, if the accumulated sum of the volumes of up to jth smallest particle is 49.8% of the total volume and that up to the (j+1)st smallest particle is 50.3% of the total volume, the diameter of the jth particle is determined as the mean diameter of the particles. The mean particle diameter dm can be expressed as follows: dₘ=dⱼ if |50−Sj| is minimum, wherein

$$Sj = ( {\sum }_{1}^{j} {di}^{3} / {\sum }_{1}^{n} {di}^{3} ) \times 100 ,$$

i=1, 2, 3, . . . , n with n being not less than 300 and being the total number of primary particles used in obtaining dₘ, dᵢ being a diameter of an ith particle and dᵢ≧dᵢ₋₁.

The dielectric ceramic powder can be formed of a barium titanate, a calcium titanate, a magnesium titanate or a lead-based dielectric material. Examples of a titanate-based material may include BaTiO₃, Bi₄Ti₃O₁₂, (Ba, Sr, Ca)TiO₃, (Ba, Ca)(Zr, Ti)O₃, (Ba, Sr, Ca)(Zr, Ti)O₃, Ba(Ti, Sn)O₃, Ba(Ti, Zr)O₃, CaTiO₃(Sr,Ca)TiO₃, (Sr, Ca)(Ti, Zr)O₃, MgTiO₃ and combinations thereof. Examples of a lead-based material may include Pb(Zn, Nb)O₃, Pb(Fe, W)O₃, Pb(Fe, Nb)O₃, Pb(Mg, Nb)O₃, Pb(Ni, W)O₃ and Pb(Mg, W)O₃. Further, the dielectric ceramic powder may be fabricated by a method of solid state reaction synthesis method, a method of obtaining fine particles by grinding the powder made by the solid state synthesis reaction method, a hydrothermal synthesis method, an alkoxide route method, a sol-gel method, a colloidal method, etc.

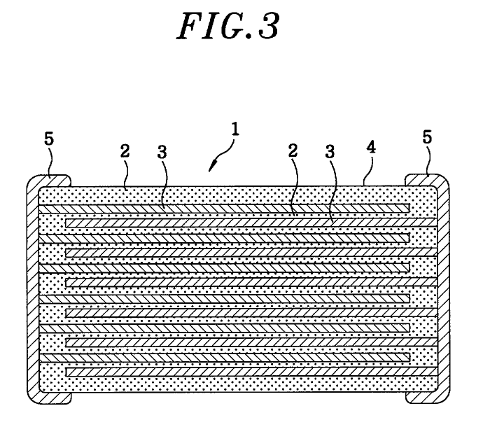

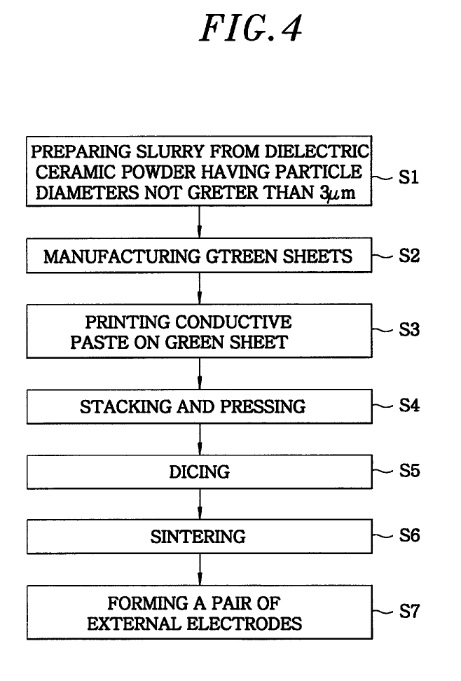

A ceramic green sheet and a multilayer ceramic capacitor in accordance with a preferred embodiment of the present invention will now be discussed with reference to FIGS. 3 and 4. FIG. 3 shows a cross-sectional view of an exemplary multilayer ceramic capacitor and FIG. 4 illustrates a manufacturing process thereof.

The feature of the ceramic green sheets in accordance with the preferred embodiment of the invention is that they are made of a slurry whose major component is the dielectric ceramic powder, the dielectric ceramic powder having the primary particles, wherein the maximum of the diameters of the primary particles is less than 3 μm, and preferably less than 1 μm. The feature of the multilayer ceramic capacitor of the present invention is that such ceramic green sheets are used for making same.

As shown in FIG. 3, a multilayer ceramic capacitor 1 includes a laminated body 4 having alternately stacked ceramic dielectric layers 2 and conductive layers 3 and a pair of external electrodes 5 formed at two opposite end portions of the laminated body 4. Each of the ceramic dielectric layers 2 is typically made of a, e.g., barium titanate-based, ferroelectric sintered body. The conductive layers 3 are formed of a metallic material, e.g., Ni, Pd, Ag and the like. The external electrodes 5 are made of such metallic material as Ni, Ag, and Cu.

The multilayer ceramic capacitor 1 is manufactured by a process illustrated in FIG. 4. First, a ceramic slurry is prepared in step S1 by mixing and agitating dielectric ceramic powder as a main component, a maximum of diameters of primary particles included in the dielectric ceramic powder being less than 3 μm, addititives, an organic binder and an organic solvent or water.

In step S2, ceramic green sheets are obtained from the ceramic slurry through the use of a tape casting technique such as a doctor blade method.

Then, in step S3, conductive paste is printed in a predetermined pattern on the ceramic green sheets by using a screen printing method, an intaglio printing method, a relief printing method, a calender•roll method, or a sputtering method.

Thereafter, in step S4, a laminated ceramic green body is obtained by stacking and pressing the ceramic green sheets in a press and pressing. In step S5, the laminated ceramic green body is then diced to produce capacitor chips of a predetermined size. Subsequently, in step S6, sintered bodies are obtained by sintering the capacitor chips at a predetermined temperature under a desired atmospheric condition. Finally, in step S7, external electrodes are formed at two end portions of each sintered body by, e.g., a dipping method, so that the multilayer ceramic capacitor 1 is obtained.

In accordance with the present invention, the ceramic dielectric layers of a multilayer ceramic capacitor are fabricated by using the dielectric ceramic powder of the present invention as a major component thereof, wherein the maximum diameter of the primary particles in the dielectric ceramic powder of the invention is not greater than 3 μm. As a result, the thickness of the ceramic dielectric layers can be scaled down without increasing the defect generation rate and therefore, a multilayer ceramic capacitor can be miniaturized and greater capacitance can be obtained by stacking an increased number of ceramic dielectric layers without deteriorating the yield.

### EXAMPLE 1

Multilayer ceramic capacitors were fabricated by using various dielectric ceramic powders and defect ratios were compared with each other. Here, three dielectric ceramic powders (A to C) manufactured in accordance with the present invention and one comparative conventional dielectric ceramic powder (X) were used. Each ceramic dielectric powder was used for manufacturing three ceramic green sheets with the thicknesses of 15, 8 and 3 μm. By using these green sheets, a multilayer ceramic capacitor was manufactured to have 20 laminated layers. Details of each dielectric ceramic powder are as follows.

The dielectric ceramic powder A was the BaTiO₃ powder fabricated through the reaction BaCO₃+TiO₃→BaTiO₃ by using the solid phase reaction synthesis method. A mean particle diameter of the BaTiO₃ powder was measured to be 0.5 μm by an SEM and 0.7 μm by a laser diffraction particle size analyzer. The maximum particle diameter of the primary particles was not greater than 3 μm. The primary particles denote BaTiO₃ particles as obtained by the reaction supra. 100 moles of the ceramic powder A as a main component were mixed with additives of Ho₂O₃ 1.0 moles, MgO 0.8 moles, MnO 0.1 moles and SiO₂ 1.0 moles to fabricate a slurry.

The dielectric ceramic powder B was obtained by grinding the ceramic powder A with ZrO₂ beads whose diameter was 1.5 mm. A mean particle diameter of the ceramic powder B was measured to be 0.4 μm by the laser diffraction particle size analyzer and the maximum particle diameter of the primary particles was not greater than 3 μm. The primary particles in this case denote particles as obtained by grinding.

The dielectric ceramic powder C was manufactured by calcining, for 10 to 20 hours at 950° C., BaTiO₃ powder fabricated by the hydrothermal synthesis technique and having a mean particle diameter of 0.1 μm. The mean particle diameter of the dielectric ceramic powder C was measured to be 0.22 μm by the SEM and 0.25 μm by the laser diffraction particle size analyzer. The maximum particle diameter of the primary particles of the dielectric ceramic powder C was not greater than 3 μm. The primary particles in this case denote particles as obtained by the calcination process.

The comparative dielectric ceramic powder was prepared by using the same composition and manufacturing method as in the dielectric ceramic powder A. The mean particle diameter of the dielectric ceramic powder C was measured to be 0.52 μm by the SEM and 0.7 μm by the laser diffraction particle size analyzer. However, 0.1% of the primary particles of the dielectric ceramic powder X were greater than 3 μm.

The ratios of defective multilayer ceramic capacitors, i.e., defective ratios, manufactured by the dielectric ceramic powders described above are shown in TABLE 1 below. The term “defective multilayer ceramic capacitors” used herein represents capacitors exhibiting short circuit failures as a result of a series of insulation tests performed on sintered multilayer capacitors.

TABLE 1

| | mean | amount of primary | | | | | |
|---|---|---|---|---|---|---|---|
| | particle | particle (%) | | | Defect ratio (%) | | |
| | diameter | particle diameter | | | Sheet thickness | | |
| powder | (μm) | | 2-3 μm | 3-4 μm | 15 μm | 8 μm | 3 μm |
| A | 0.7 | 0.8 | 0.01 | 0 | 0 | 0 | 0.01 |
| B | 0.4 | 0.5 | 0 | 0 | 0 | 0 | 0 |
| C | 0.25 | 0.01 | 0 | 0 | 0 | 0 | 0 |
| X | 0.7 | 3 | 0.8 | 0.1 | 4 | 20 | 76 |

As shown in TABLE 1, the defective ratio of the multilayer ceramic capacitors manufactured by using the dielectric ceramic powders A, B, C of the present invention remains low even for the thin dielectric layers. This is because that the dielectric ceramic powders of the present invention do not include large primary particles. Therefore, the thickness of the dielectric ceramic layers of a multilayer ceramic capacitor can be scaled down without suffering from defect generation problems of the prior art, resulting in the improved yield to be obtained from miniaturizing high capacitance multilayer ceramic capacitors.

While the invention has been shown and described with respect to the preferred embodiments, it will be understood by those skilled in the art that various changes and modifications may be made without departing from the spirit and scope of the invention as defined in the following claims.

What is claimed is:

1. Dielectric ceramic powder for use in forming dielectric layers of a multilayer ceramic capacitor, wherein a maximum diameter of primary particles in the dielectric ceramic powder is not greater than 3 μm.

2. The dielectric ceramic powder of claim 1, wherein the maximum diameter of the primary particles in the dielectric ceramic powder is not greater than 1 μm.

3. The dielectric ceramic powder of claim 1, wherein the maximum diameter of the primary particles in the dielectric ceramic powder is not greater than three times a mean particle diameter.

4. The dielectric ceramic powder of claim 3, wherein the mean diameter dₘ is defined as:
dₘ=dⱼ if |50−Sj| is minimum, wherein
$$Sj = ( {\sum }_{1}^{j} {di}^{3} / {\sum }_{1}^{n} {di}^{3} ) \times 100 ,$$
i=1 to n with n being total number of particles used in obtaining dₘ, n≧300, dᵢ being a diameter of an ith particle and dᵢ≧dᵢ₋₁.

5. A ceramic green sheet formed by using the dielectric ceramic powder of claim 1.

6. A multilayer ceramic capacitor fabricated by using the ceramic green sheet of claim 5.

7. A method for manufacturing the multilayer ceramic capacitor of claim 6.

8. The method of claim 7, wherein the maximum diameter of the primary particles in the dielectric ceramic powder is not greater than 1 μm.

9. The method of claim 7, wherein the maximum diameter of the primary particles in the dielectric ceramic powder is not greater than three times a mean particle diameter.

10. The method of claim 9, wherein the mean diameter dₘ is defined as:
dₘ=dⱼ if |50−Sj| is minimum, wherein
$$Sj = ( {\sum }_{1}^{j} {di}^{3} / {\sum }_{1}^{n} {di}^{3} ) \times 100 ,$$
i=1 to n with n being the total number of particles used in obtaining dₘ, m≧300, dᵢ being a diameter of an ith particle and dᵢ≧dᵢ₋₁.
